(19) United States
(12) Patent Application Publication
(10) Pub. No.: US 2016/0369766 A1
(43) Pub. Date: Dec. 22, 2016

(54) WAVE ENERGY CONVERSION APPARATUS

(71) Applicant: AW-ENERGY OY, Vantaa (FI)

(72) Inventors: Arvo JÄRVINEN, Vantaa (FI); Petri LIUKKONEN, Tuusula (FI); Sami PASANEN, Vantaa (FI); Lauri PIETIKÄINEN, Helsinki (FI)

(73) Assignee: AW-ENERGY OY, Vantaa (FI)

(21) Appl. No.: 15/101,785

(22) PCT Filed: Dec. 5, 2013
(86) PCT No.: PCT/FI2013/051146

§ 371 Date: Jun. 3, 2016

(51) Int. Cl. F03B 13/18; H02K 7/18; H02K 7/06; F03B 13/26; F03B 13/10

(52) U.S. Cl. CPC F03B 13/182; F03B 13/262; F03B 13/10; H02K 7/06; H02K 7/1853; F05B 2260/402; F05B 2260/40311; F05B 2240/97; F05B 2250/141; F05B 2220/706

(57) ABSTRACT

This invention relates to a wave energy conversion apparatus comprising at least a base, a reciprocating panel, supporting legs and a pivot shaft for the reciprocating panel, and a power-take-off machinery equipped with a generator comprising a rotor, in which apparatus the panel is hinged at its lower edge onto the stationary supporting legs to make a reciprocating motion in response to kinetic energy of waves or tidal currents. The apparatus comprises an actuating mechanism to convert the power of the circumferential speed of the reciprocating panel at a distance point being situated at the area of the upper half of the panel mechanically to a rotational movement of the rotor of the generator of the power-take-off machinery.

The present invention relates to a wave energy conversion apparatus as defined in the preamble of claim 1.

The wave energy conversion apparatus according to the invention is suited very well for instance to be used in connection with a panel or flap or essentially platelike wing element hinged with its lower edge to make a reciprocating movement caused by wave energy or tidal energy of seawater. The wave energy or tidal energy collected is further converted underwater with the remote controlled conversion unit for instance to electric energy. For the sake of simplicity, only the term wave energy is later mentioned when both the wave energy and the tidal energy of seawater are meant.

According to prior art there are various types of wave energy conversion systems where the arrangements include a base and, for instance, one or more panels or flaps or wings of plate type, later called shorter only as panels, pivotally connected to the base to make a reciprocating or oscillating movement about a rotation axis in response to wave forces or tidal forces. The oscillating movement is then converted for example to electric energy with the help of a generator or alike.

Typically a power-take-off machinery (PTO) of prior art wave energy conversion units is connected to a pivot shaft on which the panels are pivotally assembled to make an oscillating movement, like shown in the international patent publication No. WO2007019608A1. The pivot shaft mentioned is, for instance, at a lower edge of the reciprocating panel. WO2007019608A1 mentions that the pivot shaft drives the rotor of a machine in the form of a permanent magnet synchronous motor/generator. The problem with the solution according to WO2007019608A1 and with other similar prior art solutions is that the motor/generator is on the pivot shaft whose oscillating speed of rotation is very slow. In order to achieve sufficient power take-off the speed of rotation must be increased. Because there are very big forces and torques on the pivot shaft the gearing used to increase the speed must also be massive and robust, which leads to big and expensive structures.

Because of the massive forces and torques on the pivot shaft hydraulic power-take-off arrangements are often used in connection with submersible wave energy conversion units. International patent publication No. WO2006100436A1 shows one type of a submersible wave energy conversion unit where hydraulic cylinders are connected with pivotally attached driving rods to the flap portion or panel of the unit. However, also hydraulic power-take-off arrangements used must be big and robust, and then they are also expensive. Another problem with hydraulic power-take-off arrangements is that they require a lot of maintenance and their lifetime is considerably short.

Because relatively slow oscillating speed of rotation and massive forces and torques have led to big and robust structures of the apparatuses, it is common to all prior art wave energy conversion arrangements that their power to weight ratio is relatively poor. And in addition a hydraulic arrangement that usually must be used, is only an additional intermediate circuit between the panel and the generator causing its own usability problems and reducing the coefficient of efficiency of the apparatus.

The object of the present invention is to eliminate the drawbacks described above and to achieve a reliable, compact, economical and efficient wave energy conversion apparatus in order to be able to capture a maximum amount of available wave energy. One object of the present invention is to make the installation and maintenance of the wave energy conversion apparatus easy and fast. Yet one object of the present invention is also to achieve an apparatus that is easy to transport to the installation site. The wave energy conversion apparatus according to the invention is characterized by what is presented in the characterization part of claim 1. Other embodiments of the invention are characterized by what is presented in the other claims.

The solution of the invention has the advantage that thanks to its innovative power-take-off arrangement the power to weight ratio of the wave energy conversion apparatus according to the invention is much bigger than the power to weight ratio of the prior art arrangements. So, coefficient of efficiency improves and the structure of the apparatus can be smaller and simpler, which makes the apparatus more inexpensive to manufacture. The big advantage is that robust hydraulic arrangements are no more needed because dominant greater forces and torques are not focused to the power conversion unit. This makes the lifetime of the apparatus and also maintenance intervals longer. A further advantage is that easily available and relatively inexpensive commercial components can be used in many places of the apparatus. For instance, when the dominant force affecting to the power-take-off arrangement is decreasing and speed affecting to the power-take-off arrangement is increasing, the gearing for increasing the speed of rotation of the generator, can be smaller and much lighter than the gearings of the prior art apparatuses. That leads to a further advantage of the invention that is a possibility to use several different techniques for power-take-off. A still further advantage is that thanks to its small and lightweight structure it is easy to be assembled in its installation site without big machines and cranes. And it can even be transported by floating to its installation site using a pontoon frame, and then immerse onto the bottom of the sea in its production site. Thus electricity can be brought fast for instance to a catastrophe area.

In the following, the invention will be described in detail by the aid of two examples by referring to the attached simplified and diagrammatic drawings, wherein

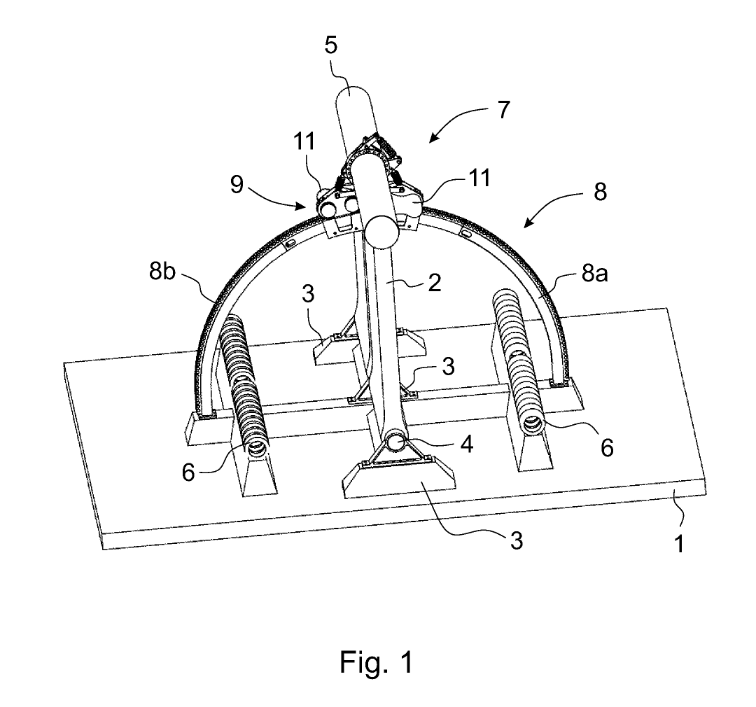

FIG. 1 presents a simplified oblique top view of a wave energy conversion apparatus according to the invention,

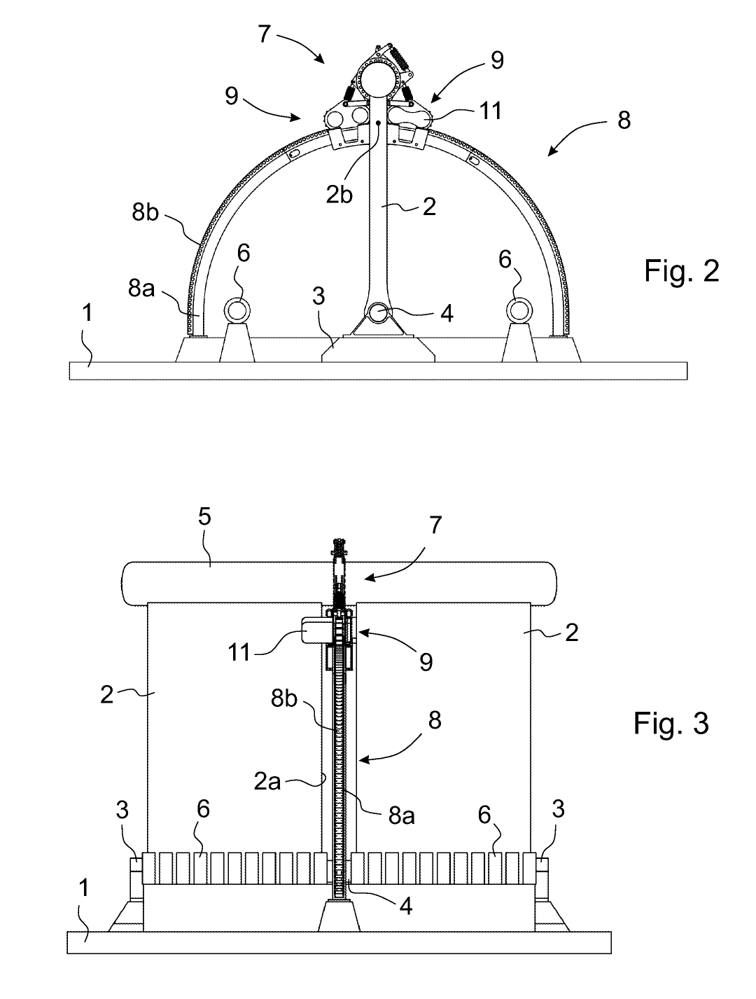

FIG. 2 presents in a side view, and in a simplified and diagrammatic way a wave energy conversion apparatus according to the invention,

FIG. 3 presents in a front view a wave energy conversion apparatus according to FIG. 2,

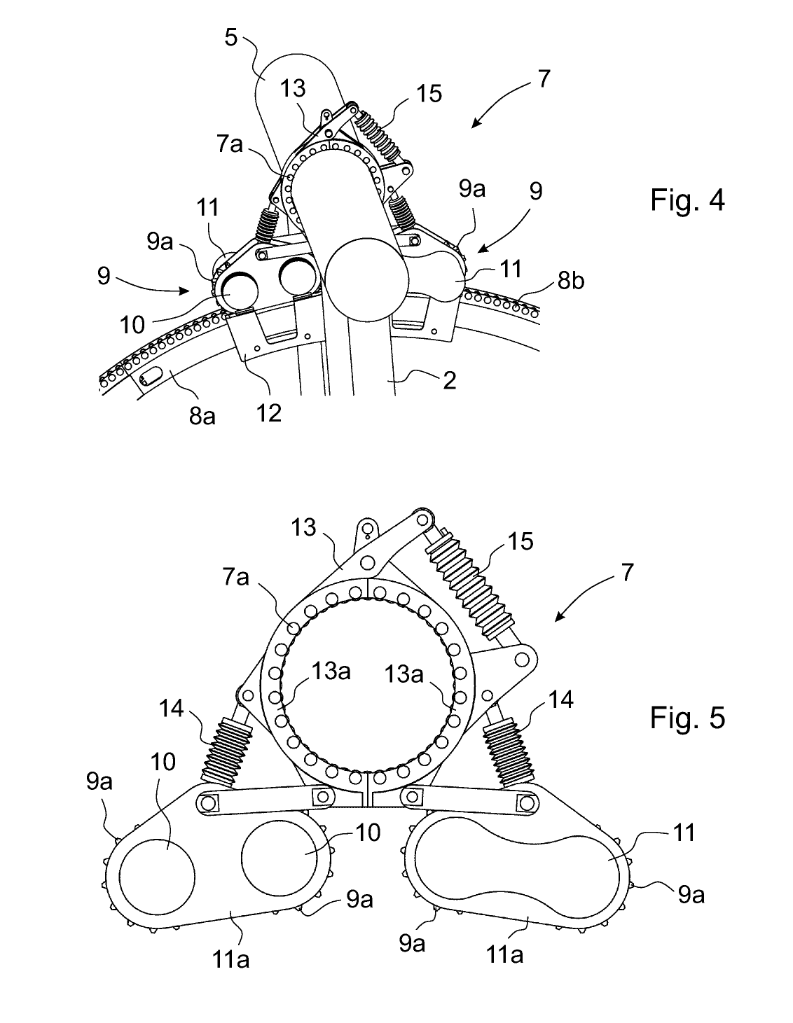

FIG. 4 presents in an enlarged oblique top view, and in a simplified and diagrammatic way an upper edge of the panel of the wave energy conversion apparatus with a power-take-off arrangement connected to the upper edge of the panel,

FIG. 5 presents in a side view, and in a simplified and diagrammatic way a power-take-off arrangement according to the invention,

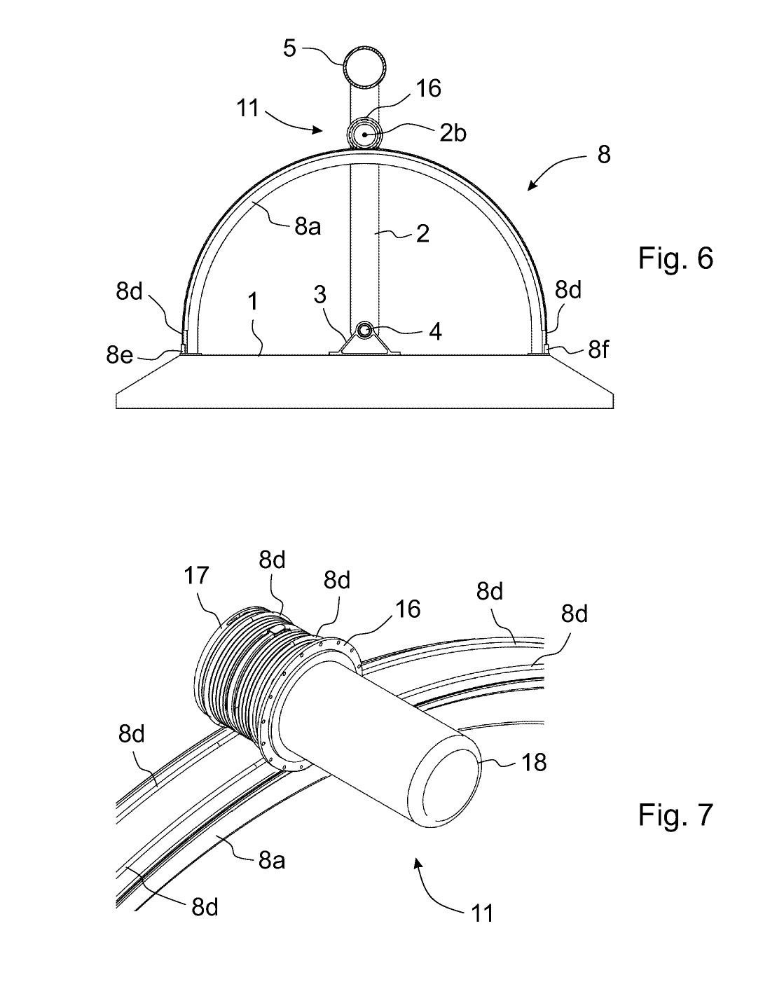

FIG. 6 presents in a side view, and in a simplified and diagrammatic way a wave energy conversion apparatus according to another embodiment of the invention,

FIG. 7 presents in an enlarged oblique top view, and in a simplified and diagrammatic way a power-take-off machinery of a wave energy conversion apparatus according to FIG. 6,

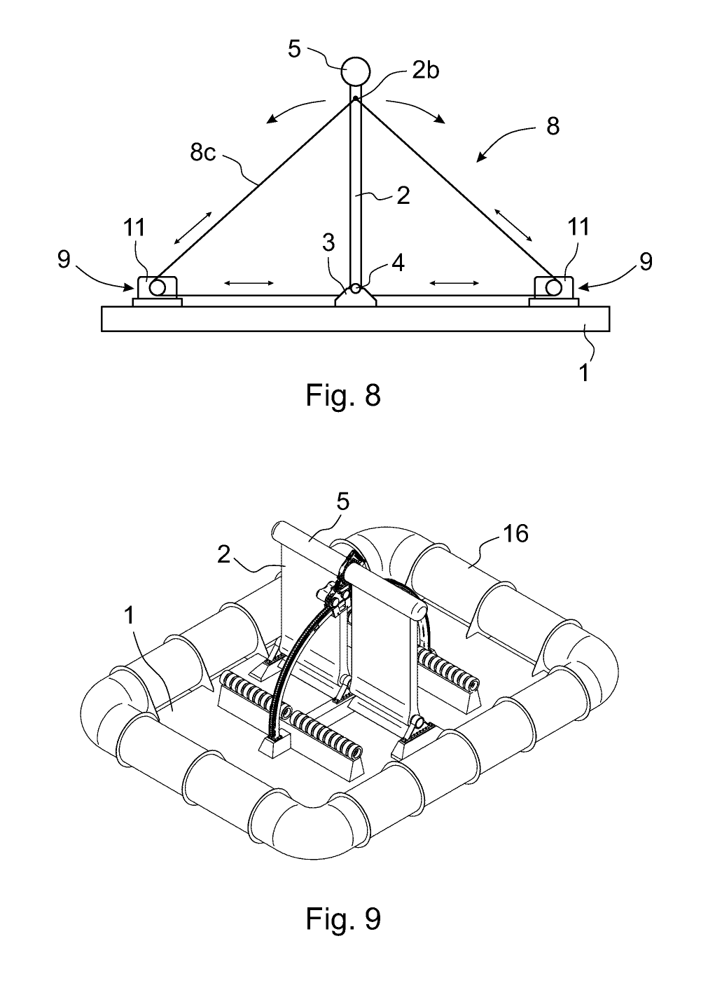

FIG. 8 presents in a side view, and in a simplified and diagrammatic way a wave energy conversion apparatus according to yet another embodiment of the invention, and

FIG. 9 presents an oblique top view of a wave energy conversion apparatus according to the invention equipped with pontoons for transport purposes.

The basic idea of the present invention is to place the power-take-off arrangement of the power-take-off machinery (PTO) as far from the center axis of the pivot shaft of the panel of the wave energy conversion apparatus as possible. Thus, the force of the movement of the reciprocating panel caused by wave energy is focused directly to the power-take-off arrangement or even to the power-take-off machinery (PTO) without any additional intermediary equipment, and consequently the power-take-off machinery (PTO) can utilize only the effective force produced by the movement of the panel. This means that a big torque on the pivot shaft does not burden the power-take-off machinery (PTO), and therefore it can be made smaller and lighter than the power-take-off machineries according to the prior art.

FIGS. 1-3 present a wave energy conversion apparatus according to the invention in three different views. The wave energy conversion apparatus comprises at least a base 1, a reciprocating panel 2, one or more power-take-off machineries (PTO) 11, an actuating mechanism 8 and one or more gearing mechanisms 9. The actuating mechanism 8 and gearing mechanisms 9 together are arranged to convert a reciprocating motion of the panel 2 mechanically to a rotational motion of the generator rotor of the power-take-off machineries 11. The mechanical conversion here means a conversion with the help of a gearing or a lever mechanism, but not a conversion with the help of a hydraulic arrangement.

The reciprocating panel 2 oscillates on the base 1 back and forth with the movement of seawater for recovering kinetic energy like wave energy of seawater. At the production site the base 1 is mounted onto the bottom of the sea. On the base 1 there are advantageously three supporting legs 3 that are fastened onto the base 1 so that one supporting leg 3 is situated at each side of the panel 2 and one supporting leg 3 is situated horizontally in the middle of the panel 2 where there is a vertical gap 2a between the two halves of the panel 2. At its upper end each supporting leg 3 supports an essentially horizontal stationary pivot shaft 4 on which the two halves of the panel 2 are mounted at their lower edges by bearings so that the panel 2 can make a reciprocating motion along the movement of the seawater, for instance along the movement of waves. The pivot shaft 4 can be a common shaft reaching from the first side of the panel 2 to the second side of the panel 2, or it can advantageously be formed from several separate parts, for instance from three separate parts so that one part is at each outer side of the panel 2 and one common shaft part to both the halves of the panel 2 is horizontally in the middle of the panel 2.

An essentially hollow cylindrical floating element 5 is fastened to the upper edge of the panel 2 reaching about from the first side of the panel 2 to about the second side of the panel 2. In addition the wave energy conversion apparatus according to the invention contains buffer elements 6 on both sides of the panel 2 in the direction of the movement of the panel 2. If the movement of the panel 2 is going too far the buffer elements 6 slow the movement down and finally stop the movement.

The support structure 7 of the power-take-off machineries (PTO) 11 of the wave energy conversion apparatus according to the invention is situated at the top part of the panel 2 as close to the upper edge of the panel 2 as possible. It can be said that the power-take-off machineries 11 are situated at the area of the upper fourth, third or half of the panel 2, or more commonly at the area of the furthermost fourth, third or half of the panel 2 from the pivot shaft 4, if the pivot shaft is, for instance, at the upper edge of the panel 2 or at one side edge of the panel 2. Generally speaking, the power-take-off machineries 11 are situated as far from the center axis of the pivot shaft 4 as possible.

In the horizontal direction the support structure 7 is essentially in the middle of the panel 2, comprising at least the gearing mechanism 9 and the power-take-off machinery 11 equipped with power conversion units such as generators that convert the reciprocating movement of the panel 2 to electric energy. The support structure 7 is pivotally connected to the cylindrical floating element 5 to make a reciprocating movement along with the panel 2, and the gearing mechanism 9 at the lower part of the support structure 7 is guided by an immovable semicircular arch 8a equipped with a roller track 8b that produces the rotational movement to the rotor of the generators of the power-take-off machineries 11 through the gearing mechanisms 9 that run on the roller track 8b when the panel 2 is reciprocating.

The semicircular arch 8a of the actuating mechanism 8 is situated horizontally in the middle of the panel 2 in the vertical gap 2a between the two parallel halves of the panel 2. The arch 8a is fastened static on the base 1, and situates symmetrically in relation to the panel 2 in perpendicular and longitudinal direction of the base 1. In addition the radius of the roller track 8b is essentially the same as the distance of the gearing mechanism 9 of the support structure 7 from the center axis of the pivot shaft 4. Thus, the semicircular roller track 8b has a radius of the pitch circle bigger than the half of the height of the panel 2, and the semicircular roller track 8b has the same center point and radius as its concentric circle whose center point is in the center axis of the pivot shaft 4. When the panel 2 is making its reciprocating movement the gearing mechanism 9 follows smoothly the movement of the panel 2 on the roller track 8b.

The actuating mechanism 8 together with the gearing mechanism 9 have been arranged to convert the reciprocating movement of the panel 2 to a rotational movement of the generator rotor of the power-take-off machinery 11. The power of the reciprocating movement of the panel 2 is captured at a distance point 2b of the panel 2. Advantageously the distance point 2b situates relatively far from the center axis of the pivot shaft 4 of the panel 2, for instance at the area of the furthermost fourth, third or half of the panel from the center axis of the pivot shaft 4, advantageously as far from the center axis of the pivot shaft 4 as possible. At the distance point 2b mentioned the circumferential speed of the reciprocating panel 2 is much bigger than near the pivot shaft 4 and also the torque is smaller than on the pivot shaft 4. According to the invention the power of the circumferential speed of the reciprocating panel 2 is captured at the distance point 2b or around the area of the distance point 2b, and converted to a rotational movement of the generator rotor of the power-take-off machinery 11. The distance point 2b can also be called as a distance level, and the distance point 2b acts as a power take-of point that is separated from the supporting point of the panel 2, which is the pivot shaft 4. This means that at the point of power take-off all the forces are led to separate places compared to the supporting forces of the panel 2 that are led through the supporting legs 3 to the base 1, whereas the forces at the point of power take-off are led through the arch 8 to the base 1 at the fastening locations of the arch 8.

FIGS. 4 and 5 present in a more detailed way the support structure 7 of the power-take-off machinery 11 according to the invention. FIG. 4 presents in an enlarged oblique top view, and in a simplified and diagrammatic way an upper edge of the panel 2 of the wave energy conversion apparatus with the support structure 7 connected to the upper edge of the panel 2, and FIG. 5 presents in a side view, and in a simplified and diagrammatic way the support structure 7 according to the invention alone.

The support structure 7 according to the invention comprising one or more gearing mechanisms 9 and power-take-off machineries 11 is made as one entity that can easily be assembled in its final location or, if needed, easily be lifted up from its location for replacement or maintenance, for example. According to one advantageous embodiment the support structure 7 is pivotally connected to the cylindrical floating element 5 of the panel 2 by a bearing arrangement 7a. This makes it possible for the support structure 7 to pliantly follow the roller track 8b when the panel 2 is reciprocating. The support structure 7 comprises also a lever mechanism 13 that closes the support structure 7 around the floating element 5 and opens the structure when the support structure 7 is lifted up from its location. The closing and opening of the lever mechanism 13 is activated by an actuator 15.

The energy conversion part of the support structure 7 comprises a group of power-take-off machineries 11, for instance 2, 3, 4 or 6, or even more power-take-off machineries 11, each having a generator to convert the reciprocating movement of the panel 2 to electric energy. The power-take-off machineries 11 can be situated on both sides of the panel 2 in the direction of the movement of the panel 2, and mutually at different sides of the support structure 7. Each generator of the power-take-off machinery 11 is connected to the gearing mechanism 9 that comprises a follow-up gear 9a that runs along the roller track 8b and at the same time rotates around its own center axis. The follow-up gear 9a is arranged to produce its rotational movement to a planetary gear 10 that for its part produces an increased rotational movement to the shaft of the generator rotor.

Thus, the circumferential speed of the support structure 7 on the roller track 8b produces a multiple rotational speed to the generator rotor of each power-take-off machinery 11. Because the support structure 7 is far from the center axis of the pivot shaft 4 the circumferential speed of the support structure 7 is already multiple compared to the circumferential speed close to the pivot shaft 4. So, the rotational speed of the generator rotor achieved is much bigger than in prior art solutions.

The solution according to the embodiment explained comprises for instance two power-take-off units 11a having two power-take-off machineries 11 and two gearing mechanisms 9 each. The first power-take-off unit 11a is at the first side of the panel 2 and the second power-take-off unit 11a is at the second side of the panel 2. In addition the lever mechanism 13 comprises buffer elements 14 that are arranged to yield if the gearing mechanisms 9 of the power-take-off units 11a do not follow the roller track 8b smoothly enough. When using the buffer elements 14 the bearing arrangement 7a is not necessary but it can still be used. The guiding means 12 shown in FIG. 4 are not necessary when using the buffer elements 14 and therefore the guiding means 12 are not shown in another embodiment in FIG. 5. The support structure 7 comprises also a cradle element that consists of two cradle halves 13a that together form a supporting circle around the cylindrical floating element 5. The cradle element can be opened and closed at its lowermost point by the lever mechanism 13 when the support structure 7 is lifted up or assembled at its location.

The electric energy output cable from the generators of the power-take-off machineries 11 can be situated for instance on the surface of the panel 2 and can be led out of the wave energy conversion apparatus along the side of the pivot shaft 4.

FIGS. 6 and 7 present in a side view and in an enlarged oblique top view, and in a simplified and diagrammatic way a wave energy conversion apparatus according to another embodiment of the invention. In FIG. 6 the first half of the panel 2 is presented in the direction of the center axis of the pivot shaft 4 and the second half of the panel 2 is removed in order to make the arch 8a of the actuating mechanism 8 and the power-take-off machinery 11 entirely visible. The arch 8a is situated essentially in the same location and is basically similar to the arch 8a shown in FIG. 1-3 but now the upper surface of the arch 8a is essentially flat or contains longitudinal grooves for motion transmission elements 8d, such as ropes or alike, later called ropes 8d. The number of ropes 8d can vary, and it can be for instance 1, 2, 3, 4 or even more than 4. In the embodiment described the number of ropes 8d is two. The first end 8e of each rope 8d is fastened to the base 1 near the first end of the arch 8a, and the second end 8f of each rope 8d is fastened to the base 1 near the second end of the arch 8a. The ropes 8d are supported by the flat upper surface of the arch 8a from their first end 8e to their second end 8f, except at the point of the panel 2 where the ropes 8d are arranged to make a tight loop around a grooved rotary drum 17 that acts as a rotating element for the rotor of the generator of the power-take-off machinery 11. In this embodiment the arch 8a, ropes 8d and the drum 17 form the actuating mechanism 8 of the apparatus. The ropes 8d can be also replaced by chains or bands.

The power-take-off machinery 11 is one entity comprising at least a framework, the drum 17, a fastening flange 16, a tubular case 18 and a generator that is situated inside a tubular case 18. The framework, fastening flange 16 and the tubular case 18 form a non-rotary part of the entity that is fastened to the panel 2, to reciprocate along with the panel 2, by the help of the fastening flange 16 so, that the tubular case 18 with the generator is fitted inside one half of the panel 2. Correspondingly the drum 17 is situated in the gap 2a between the two halves of the panel 2. The fastening point on the panel 2 is at the distance point 2b mentioned above or around the area of the distance point 2b so, that for instance the center axis of the rotary drum 17 is at the level of the distance point 2b.

The drum 17 is a rotary part of the entity and has been rotatably mounted in bearings on the framework of the entity. When the panel 2 is making its reciprocation motion the power-take-off machinery 11 with its drum 17 moves with the panel 2 and the tight loops of the ropes 8d around the drum 17 rotate the drum 17 around its center axis and further the drum 17 rotates the rotor of the generator of the power-take-off machinery 11. Thus the power of the circumferential speed of the reciprocating panel 2 is captured at the distance point 2b or around the area of the distance point 2b, and converted to a rotational movement of the generator rotor of the power-take-off machinery 11.

FIG. 8 presents in a side view, and in a simplified and diagrammatic way a wave energy conversion apparatus according to yet another embodiment of the invention. Instead of situating movably near the top edge of the panel 2 the power-take-off machineries 11 are fixedly situated on the base 1 at both sides of the panel 2 in the direction of the movement of the panel 2. A certain motion transmission element 8c, such as a chain or a group of parallel chains, or a rope or a group of parallel ropes, or a band or a group of parallel bands acts now as the actuating mechanism 8 that runs the gearing mechanism 9 of the power-take-off machineries 11. The motion transmission element 8c is fastened to the panel 2 at the distance point 2b that is near the upper edge of the panel 2 as explained earlier so that the motion transmission element 8c moves along with the reciprocating movement of the panel 2. The motion transmission element 8c forms a closed loop that is arranged to rotate the gearing mechanism 9 in the same cycle as the panel 2 makes its reciprocating movement.

Also in this embodiment the circumferential speed of the reciprocating panel 2 is captured at the distance point 2b and converted to a rotational movement of the generator rotor of the power-take-off machinery 11 so that the actuating mechanism 8 together with the gearing mechanism 9 have been arranged to convert the reciprocating movement of the panel 2 to a rotational movement of the generator rotor of the power-take-off machinery 11. And the power of the reciprocating movement of the panel 2 is captured at a distance point 2b of the panel 2.

It is obvious that also in this embodiment all the forces at the point of power take-off are led to separate places compared to the supporting forces of the panel 2. The forces mentioned are led through the motion transmission element 8c and the gearing mechanisms 9 to the fastening points of the power-take-off machineries 11, the locations of which differ from the locations of the supporting legs 3.

FIG. 9 presents an oblique top view of a wave energy conversion apparatus according to the invention equipped with pontoons 16 for transport purposes. During transport the pontoons 16 are filled with gas such as air, and when the wave energy conversion apparatus is above its production site the pontoons 16 are emptied or filled with water and the apparatus is descended onto the bottom of the sea. When the apparatus has to be lifted up the pontoons are filled with gas such as air and the apparatus with its base 1 ascends to the surface of the sea. The pontoons 16 can be used also to transport the wave energy conversion apparatus to a catastrophe area where for instance electric energy is needed.

It is obvious to the person skilled in the art that the invention is not restricted to the example described above but that it may be varied within the scope of the claims presented below. Thus, for example, the structure of the arch for the roller track can be different from what is presented. Then the semicircular arch can be for instance toothed instead of having rollers.

It is also obvious to the person skilled in the art that the supporting structure of the power-take-off machineries can differ from what is presented above.

1. Wave energy conversion apparatus comprising at least a base, a reciprocating panel, supporting legs and a pivot shaft for the reciprocating panel, and a power-take-off machinery equipped with a generator comprising a rotor, in which apparatus the panel is hinged at its lower edge onto the stationary supporting legs to make a reciprocating motion in response to kinetic energy of waves or tidal currents, characterized in that the apparatus comprises an actuating mechanism to convert the power of the circumferential speed of the reciprocating panel at a distance point being situated at the area of the upper half of the panel mechanically to a rotational movement of the rotor of the generator of the power-take-off machinery.

2. Wave energy conversion apparatus according to claim 1, wherein the distance point is situated at the area of the upper fourth, third or half of the panel .

3. Wave energy conversion unit according to claim 1, wherein the distance point is situated near the top edge of the panel as far from the center axis of the pivot shaft as possible, and the distance point acts as a power take-of point that is separated from the supporting point of the panel.

4. Wave energy conversion apparatus according to claim 1, wherein the actuating mechanism comprises a static semicircular arch with a semicircular roller track having a radius of the pitch circle bigger than the half of the height of the panel.

5. Wave energy conversion apparatus according to claim 4, wherein apparatus comprises a support structure comprising at least the gearing mechanism and the power-take-off machinery equipped with power conversion units such as generators that are arranged to convert the reciprocating movement of the panel to electric energy.

6. Wave energy conversion apparatus according to claim 5, wherein the support structure is connected at the top part of the panel to make a reciprocating movement along with the panel, and the gearing mechanism at the lower part of the support structure is guided by the static semicircular arch equipped with the roller track that is arranged to produce the rotational movement to the rotor of the generators of the power-take-off machineries through the gearing mechanisms that run on the roller track when the panel is reciprocating.

7. Wave energy conversion apparatus according to claim 6, wherein the support structure is pivotally connected by a bearing arrangement to a cylindrical floating element at the top part of the panel, and the support structure contains a lever mechanism that comprises buffer elements that are arranged to yield if the gearing mechanisms of the power-take-off machineries do not follow the roller track smoothly enough.

8. Wave energy conversion apparatus according to claim 7, wherein the lever mechanism comprises an actuator by the help of which the lever mechanism is arranged to close the support structure around the floating element and to open the support structure in order to lift the support structure up from its location.

9. Wave energy conversion apparatus according to claim 1, wherein the gearing mechanism comprises a follow-up gear that runs along the roller track and at the same time rotates around its own center axis, and that the follow-up gear is arranged to produce its rotational movement to a planetary gear that for its part is arranged to produce an increased rotational movement to the shaft of the generator rotor of the power-take-off machinery.

10. Wave energy conversion apparatus according to claim 1, wherein the actuating mechanism comprises a motion transmission element, such as a chain or a group of parallel chains, or a rope or a group of parallel ropes, a band or a group of parallel bands, that is fastened to the panel at the distance point that is near the upper edge of the panel, and the motion transmission element is arranged to run the gearing mechanism of the power-take-off machineries.

11. Wave energy conversion apparatus according to claim 10, wherein the power-take-off machineries and the gearing mechanisms are fixedly situated on the base at both sides of the panel in the direction of the movement of the panel.

12. Wave energy conversion apparatus according to claim 10, wherein the motion transmission element forms a closed loop that is arranged to rotate the gearing mechanism in the same cycle as the panel makes its reciprocating movement.

13. Wave energy conversion apparatus according to claim 1, wherein the actuating mechanism comprises a static semicircular arch with an essentially flat of grooved upper surface and having a radius bigger than the half of the height of the panel, and a motion transmission element, such as a rope or a group of parallel ropes, a chain or a group of parallel chains, or a band or a group of parallel bands that is fastened to the base at its both ends, and a rotary drum rotated by the motion transmission element during the reciprocating motion of the panel.

14. Wave energy conversion apparatus according to claim 13, wherein motion transmission element is supported by the upper surface of the static semicircular arch and arranged to make a tight loop around the rotary drum.

15. Wave energy conversion apparatus according to claim 13, wherein the power-take-off machinery is one entity comprising at least a framework, the drum, a fastening flange, a tubular case and a generator that is situated inside a tubular case, and the framework, fastening flange and the tubular case form a non-rotary part of the entity that is fastened to the panel by the help of the fastening flange so, that the tubular case with the generator is fitted inside one half of the panel, and the drum is situated in the gap between the two halves of the panel at or around the level of the distance point.

16. Wave energy conversion unit according to claim 2, wherein the distance point is situated near the top edge of the panel as far from the center axis of the pivot shaft as possible, and the distance point acts as a power take-of point that is separated from the supporting point of the panel.

17. Wave energy conversion apparatus according to claim 2, wherein the actuating mechanism comprises a static semicircular arch with a semicircular roller track having a radius of the pitch circle bigger than the half of the height of the panel.

18. Wave energy conversion apparatus according to claim 3, wherein the actuating mechanism comprises a static semicircular arch with a semicircular roller track having a radius of the pitch circle bigger than the half of the height of the panel.

19. Wave energy conversion apparatus according to claim 2, wherein the gearing mechanism comprises a follow-up gear that runs along the roller track and at the same time rotates around its own center axis, and that the follow-up gear is arranged to produce its rotational movement to a planetary gear that for its part is arranged to produce an increased rotational movement to the shaft of the generator rotor of the power-take-off machinery.

20. Wave energy conversion apparatus according to claim 3, wherein the gearing mechanism comprises a follow-up gear that runs along the roller track and at the same time rotates around its own center axis, and that the follow-up gear is arranged to produce its rotational movement to a planetary gear that for its part is arranged to produce an increased rotational movement to the shaft of the generator rotor of the power-take-off machinery.
